(19) United States
(12) Patent Application Publication
(10) Pub. No.: US 2007/0182868 A1
(43) Pub. Date: Aug. 9, 2007

(54) Television signal processor having dual antennas

(75) Inventor: Shih-Huai Yang, Taipei City (TW)

Correspondence Address: TROXELL LAW OFFICE PLLC, SUITE 1404, 5205 LEESBURG PIKE, FALLS CHURCH, VA, 22041, US

(73) Assignee: YUAN High-Tech Development Co., Ltd., Taipei (TW)

(21) Appl. No.: 11/480,436

(22) Filed: Jul. 5, 2006

(30) Foreign Application Priority Data
Feb. 9, 2006 (TW) 095202263

(51) Int. Cl. H04N 5/44; H04N 5/50

(52) U.S. Cl. 348/731; 348/725

(57) ABSTRACT

The present invention has two antennas to receive video/audio signals. The antennas tunes the frequency bands of the signals they receive in order to display two video/audio signals of two different bands. Or, if the antennas are tuned to receive video/audio signals of the same frequency band, the sensitivity on receiving signals is enhanced.

### FIELD OF THE INVENTION

The present invention relates to a signal processor; more particularly, relates to displaying signals of two frequency bands simultaneously; or enhancing signal-receiving sensitivity.

### DESCRIPTION OF THE RELATED ART

In a modern life, a computer has already become a daily necessity. It has been developed from the very beginning for word processing and data manipulating until now as multimedia presenting and Internet processing, like watching videos, listening to music, Internet surfing, sending and receiving e-mails, etc., which add much fun to our lives. Concerning watching television (TV) with a computer, a prior art uses a TV/PC (personal computer) switch box being connected between the computer and the TV signal line so that TV signals can be transferred to be displayed. Because the size of the TV/PC switch box is big and the TV signal line needs to be connected, it is better to be used with a desktop computer, but not the portable notebook computer. Not to mention watching TV on the Internet through a wireless connection.

To try to solve the above problem, a digital TV receiver 9 (as shown in FIG. 6) for desktop computer and notebook computer is developed. The digital TV receiver 9 comprises a control circuit board 91 to control the operations of the digital TV receiver 9; a signal receiver 92 with an antenna 921 set in the digital TV receiver 9 to receive signals sent from a digital TV broadcasting system; a TV tuner 93 to decode/encode signals received; and a connector 94 to connect with a notebook computer 90 (or a desktop computer). Thus, a digital TV receiver 9 for receiving signals of digital TV programs sent from a TV broadcasting system is obtained.

Although the above digital TV receiver is a prior art for receiving signals of digital TV programs sent from a TV broadcasting system to be displayed on a notebook computer (or a desktop computer) connected with, only one frequency band are searched with only one antenna and so the sensitivity for receiving signals of the requested frequency band is weak. In addition, only a video window is displayed but with a worse quality. Hence, the prior art does not fulfill users' requests on actual use.

### SUMMARY OF THE INVENTION

The main purpose of the present invention is to receive signals of two frequency bands through tuning the frequency bands of the signals into two different bands to be received by two signal receivers; or to enhance signal-receiving sensitivity through tuning the frequency bands of the signals into the same band.

To achieve the above purpose, the present invention is a television signal processor having dual antennas, comprising a first and a second signal receivers, where the first and the second signal receivers receive video/audio signals of requested frequency bands and the signal receivers comprise a first and a second antennas, a first and a second tuners, a first and a second infrared-rays signal-receiving units and a first and a second video/audio decoders; a video/audio transmitter connected with the video/audio decoders to receive video/audio signals from the first and the second signal receivers; an encoder connected with the video/audio transmitters to receive video/audio signals to be compressed and encoded; and a connecting unit connected with the encoder to connect to an outside electrical device for displaying the video/audio signals. Accordingly, a novel television signal processor having dual antennas is obtained.

### BRIEF DESCRIPTIONS OF THE DRAWINGS

The present invention will be better understood from the following detailed descriptions of the preferred embodiments according to the present invention, taken in conjunction with the accompanying drawings, in which

FIG. 1 is a perspective view showing the present invention;

FIG. 2 is a block view showing the first structure;

FIG. 3 is a block view showing the second structure;

FIG. 4 is a view showing the state of use of the second structure; and

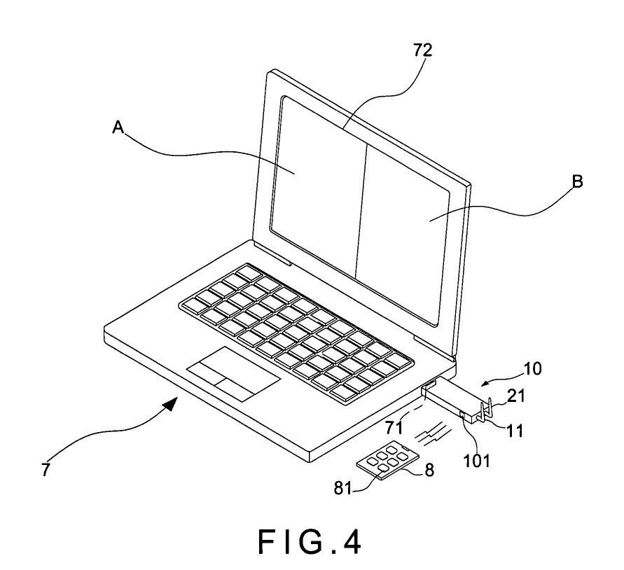

FIG. 5 is a block view showing the third structure;

FIG. 6 is a state-of-use view of a prior art.

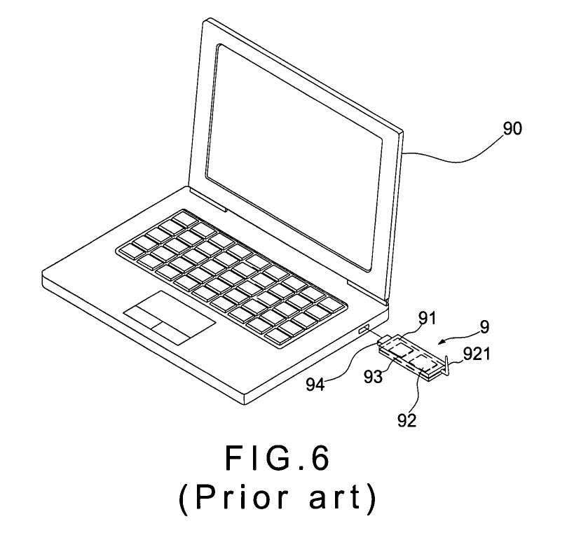

### DESCRIPTION OF THE PREFERRED EMBODIMENTS

The following descriptions of the preferred embodiments are provided to understand the features and the structures of the present invention.

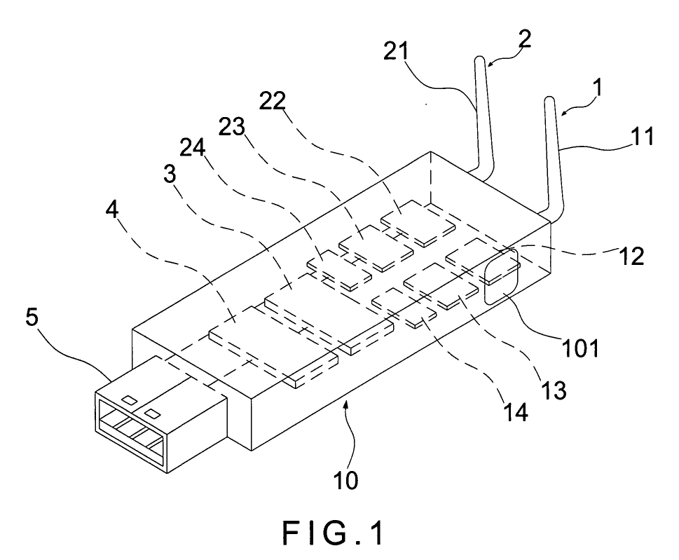

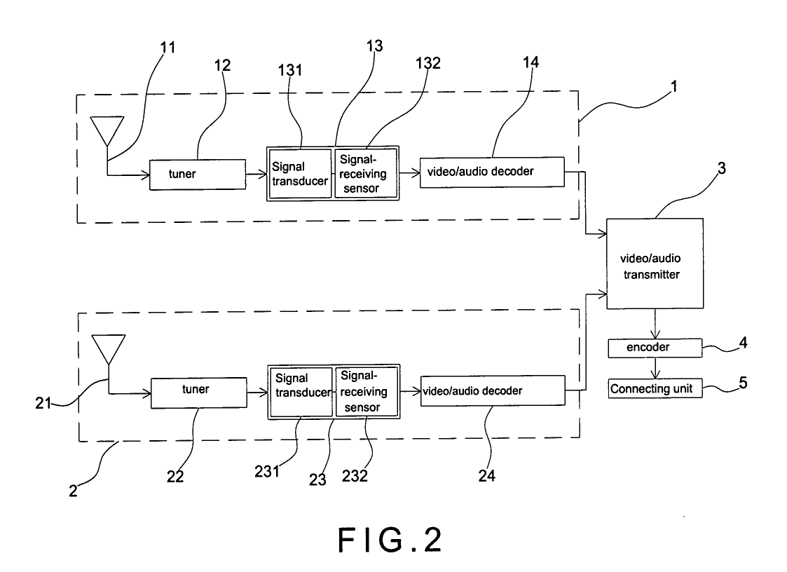

Please refer to FIG. 1 and FIG. 2, which are a perspective view showing the present invention; and a block view showing the first structure. As shown in the figures, the present invention is a television signal processor having dual antennas, comprising a first signal receiver 1, a second signal receiver 2, a video/audio transmitter 3, an encoder 4 and a connecting unit 5, where the first signal receiver 1, the second signal receiver 2, the video/audio transmitter 3, the encoder 4 and the connecting unit 5 are set in a shell 10. By tuning frequency bands of the first signal receiver 1 and the second signal receiver 2, signals from two frequency bands are received and outputted simultaneously; or, by tuning the frequency bands of the signal receivers 1,2 into the same band, signal-receiving sensitivity is enhanced.

The first signal receiver 1 receives required video/audio signals, comprising a first antenna 11; a first tuner 12 connected with the first antenna 11; a first infrared-rays signal-receiving unit 13 connected with the first tuner 12; and a first video/audio decoder 14 connected with the first infrared-rays signal-receiving unit 13, where the first infrared-rays signal-receiving unit 13 is corresponding to a window 101 at a side of the shell 10.

The second signal receiver 2 receives required video/audio signals, comprising a second antenna 21; a second tuner 22 connected with the second antenna 21; a second infrared-rays signal-receiving unit 23 connected with the second tuner 22; and a second video/audio decoder 24 connected with the second infrared-rays signal-receiving unit 23, where the second infrared-rays signal-receiving unit 23 is corresponding to the window 101 at the side of the shell 10.

The video/audio transmitter 3 is connected with the first and the second signal receivers 1,2 to receive video/audio signals from the first and the second signal receivers 1,2 to be transmitted.

The encoder 4 is connected with the video/audio transmitter 3 to receive video/audio signals transmitted from the video/audio transmitter 3 to be compressed and encoded.

The connecting unit 5 is connected with the encoder 4 to connect to an outside electrical device for displaying the video/audio signals with the outside electrical device. The connecting unit 4 is a connector to connect to the outside electrical device, which is a USB (Universal Serial Bus) connector, a Card Bus connector, an Express card connector, a PCMCIA (Personal Computer Memory Card International Association) connector, a Mini PCI (Protocol Control Information) connector, etc. Thus, a novel television signal processor having dual antennas is obtained.

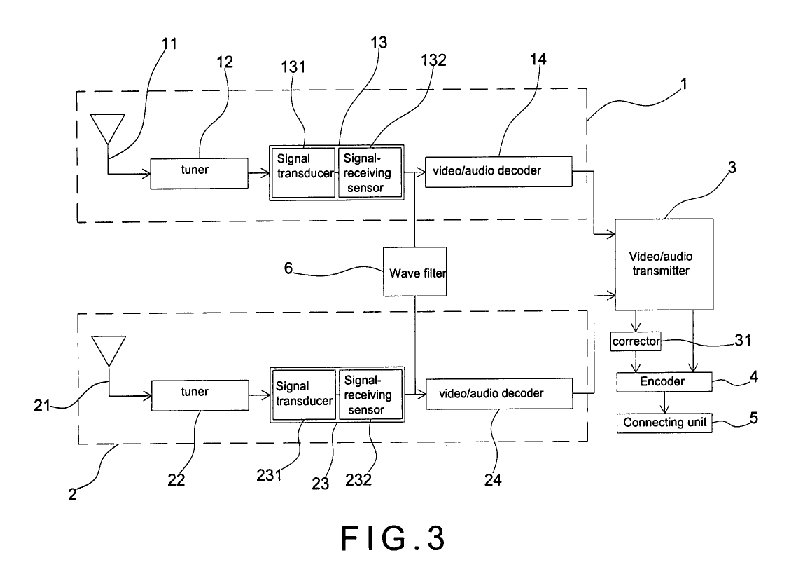

Please refer to FIG. 3, which is a block view showing the second structure. As shown in the figure, the first infrared-rays signal-receiving unit 13 comprises a first signal transducer 131, and a first signal-receiving sensor 132 connected with the first signal transducer 131. The second infrared-rays signal-receiving unit 23 comprises a second signal transducer 231, and a second signal-receiving sensor 232 connected with the second signal transducer 231. Coordinated with a remote controller, frequency bands of a first and a second signal receivers 1,2 are set and controlled. A wave filter 6, which can be a 3-dimensional cone filter, is connected between the signal receivers 1,2, where, through a 3-dimensional digital Y(luminance)/C(chroma) separation technology done with a Y/C separation circuit, luminance signals (Y) and chroma (C) signals are precisely separated to eliminate noises from interferences between colors. A corrector 31 is set between a video/audio transmitter 3 and an encoder 4, where the corrector 31 can be a Gamma corrector to distinguish levels of brightness (as those in a cloud) more clearly by selecting a lower Gamma value on the bright screen and suffering some levels of darkness.

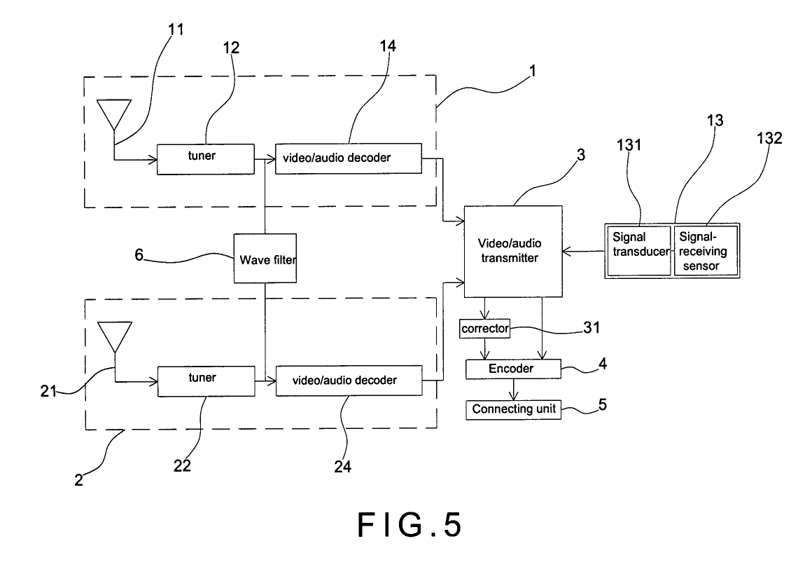

Please refer to FIG. 3 till FIG. 5, which are a block view showing the second structure, a view showing the state of use of the second structure and a block view showing the third structure. As shown in the figures, when using the present invention, an outside electrical device is connected with a connecting unit 5. For example, the connecting unit 5 can be a USB interface and the outside electrical device can be a notebook computer 7. In an implementation, the connecting unit 5 is plugged in a USB connector 71 of the notebook computer 7 for connecting the present invention with the notebook computer 7. When using the present invention, a remote controller 8 is used with its buttons 81 to transfer required setup signals and control signals to a first and a second corresponding signal receivers 1,2 coordinated with a first and a second infrared-rays signal-receiving unit 13,23. When the first and the second signal receivers 1,2 are tuned to receive signals of different frequency bands, a first and a second corresponding antennas 11,12 receive video/audio signals of different frequency bands to be transferred to a wave filter 6 and then is respectively transferred to a first and a second video/audio decoder 14,24 (Or, the video/audio signals are directly transferred to the video/audio decoder 14,24 from the first and the second tuner 12,22.) After the video/audio transmitter 3 receives the video/audio signals, the video/audio signals are transferred to an encoder 4 for required format editing (MPEG2 or MPEG4). Then the video/audio signals are transferred through the connecting unit 5 to the notebook computer 7 to be displayed with two video windows A,B (two lined windows or one big window with a smaller one) on the display 72 of the notebook computer 7, where video/audio signals of two frequency bands are displayed on two video windows A,B simultaneously.

In the other hand, when the frequency bands of signals received by the first and the second signal receivers 1,2 are tuned to be the same, the first and the second antennas receive video/audio signals of the same frequency band to be transferred to the wave filter 6 through the first and the second tuners 12,22. Then the signals are transferred from the wave filter 6 to the first and the second video/audio decoder 14,24 (Or, the signals are directly transferred to the video/audio decoder 14,24 from the first and the second tuner 12,22.) After the video/audio transmitter 3 receives the signals of the same band, the signals are transferred to the encoder 4 for required format editing (MPEG2 or MPEG4). Then the signals are transferred through the connecting unit 5 to the notebook computer 7 to be displayed on the display 72 of the notebook computer 7 with a video window. Because the first and the second signal receivers receive signals of the same frequency band, signal-receiving sensitivity is enhanced.

However, even though the first structure uses the first and the second infrared-rays signal-receiving units 13,23, the present invention can use only a third infrared-rays signal-receiving unit 33 (as shown in FIG. 5) to be connected with the video/audio transmitter 3 to receive video/audio signals of two different frequency bands, where the third infrared-rays signal-receiving unit 33 comprises a third signal transducer 331, and a third signal-receiving sensor 332 connected with the third signal transducer 331.

To sum up, the present invention is a television signal processor having dual antennas, where, through tuning the frequency bands of the signals into two different bands to be received by the first and the second signal receiver, signals of two frequency bands are displayed simultaneously; or, through tuning the frequency bands of the signals into the same band, signal-receiving sensitivity is enhanced.

The preferred embodiment(s) herein disclosed is/are not intended to unnecessarily limit the scope of the invention. Therefore, simple modifications or variations belonging to the equivalent of the scope of the claims and the instructions disclosed herein for a patent are all within the scope of the present invention.

What is claimed is:

1. A television signal processor having dual antennas, comprising:
(a) a first signal receiver, said first signal receiver receiving video/audio signals of requested frequency band, said first signal receiver comprising
(i) a first antenna;
(ii) a first tuner being connected with said first antenna;
(iii) a first infrared-rays signal-receiving unit being connected with said first tuner; and
(iv) a first video/audio decoder being connected with said first infrared-rays signal-receiving unit;
(b) a second signal receiver, said second signal receiver receiving video/audio signals of requested frequency band, said second signal receiver comprising
(i) a second antenna;
(ii) a second tuner being connected with said second
(iii) a second infrared-rays signal-receiving unit being connected with said second tuner; and
(iv) a second video/audio decoder being connected with said second infrared-rays signal-receiving unit;
(c) a video/audio transmitter, said video/audio transmitter being connected with said first video/audio decoder and said second video/audio decoder to receive video/audio signals from said first signal receiver and said second signal receiver;
(d) an encoder, said encoder being connected with said video/audio transmitter to receive video/audio signals from said video/audio transmitter to be compressed and encoded; and
(e) a connecting unit, said connecting unit being connected with said encoder, said connecting unit connecting to an outside electrical device to display said video/audio signals on said outside electrical device.

2. The processor according to claim 1,
wherein a wave filter is connected between said first signal receiver and said second signal receiver.

3. The processor according to claim 2,
wherein said wave filter is a 3-dimensional comb filter.

4. The processor according to claim 1,
wherein said first infrared-rays signal-receiving unit comprises a first signal transducer, and a first signal-receiving sensor connected with said first signal transducer; and
wherein said second infrared-rays signal-receiving unit comprises a second signal transducer, and a second signal-receiving sensor connected with said second signal transducer.

5. The processor according to claim 1,
wherein a corrector is set between said video/audio transmitter and said encoder.

6. The processor according to claim 5,
wherein said corrector is a Gamma corrector.

7. The processor according to claim 1,
wherein said connecting unit, connecting to said outside electrical device, is selected from a group consisting of a serial bus connector, a card bus connector, an express card connector, a PCMCIA (Personal Computer Memory Card International Association) connector, and a Mini PCI (Protocol Control Information) connector.

8. A television signal processor having dual antennas, comprising:
(a) a first signal receiver, said first signal receiver receiving video/audio signals of requested frequency band, said first signal receiver comprising
(i) a first antenna;
(ii) a first tuner being connected with said first antenna; and
(iii) a first video/audio decoder being connected with said first infrared-rays signal-receiving unit;
(b) a second signal receiver, said second signal receiver receiving video/audio signals of requested frequency band, said second signal receiver comprising
(i) a second antenna;
(ii) a second tuner being connected with said second antenna; and
(iii) a second video/audio decoder being connected with said second infrared-rays signal-receiving unit;
(c) a video/audio transmitter, said video/audio transmitter being connected with said first video/audio decoder and said second video/audio decoder to receive video/audio signals from said first signal receiver and said second signal receiver;
(d) a third infrared-rays signal-receiving unit being connected with said video/audio transmitter, said third infrared-rays signal-receiving unit comprising a third signal transducer, and a third signal-receiving sensor connected with said third signal transducer;
(e) an encoder, said encoder being connected with said video/audio transmitter to receive video/audio signals from said video/audio transmitter to be compressed and encoded; and
(f) a connecting unit, said connecting unit being connected with said encoder, said connecting unit connecting to an outside electrical device to display said video/audio signals on said outside electrical device.
